(19) United States
(12) Patent Application Publication
(10) Pub. No.: US 2014/0224579 A1
(43) Pub. Date: Aug. 14, 2014

(54) FALL PROTECTION SYSTEM

(71) Applicant: Allan Joseph Balascak, Edmonton (CA)

(72) Inventor: Allan Joseph Balascak, Edmonton (CA)

(21) Appl. No.: 13/766,642

(22) Filed: Feb. 13, 2013

(51) Int. Cl. E04G 21/32; A62B 35/00

(52) U.S. Cl. CPC E04G 21/328; A62B 35/0068
USPC 182/3

(57) ABSTRACT

An apparatus for protecting a worker from falling at a work site comprises a base plate operable to be anchored to a work surface, an anchor connected to the base plate and an upright extending substantially horizontally from the base plate. A system for protecting a worker from falling at a work site comprises at least one anchor plate having an anchor connected thereto, at least one indicator plate having an anchor connected thereto and an upright extending therefrom, each upright having a bore through a free distal end thereof and a flexible tension member sized to extend through the bores between the uprights.

### BACKGROUND OF THE INVENTION

1. Field of Invention

The present invention relates to fall protection systems in general and in particular to system and apparatus for providing a worker with a visual indication of a dangerous edge as well as an anchor location for fall safety equipment.

2. Description of Related Art

In many industries, such as, by way of non-limiting example, construction, workers are frequently required to work proximate to an edge of the building. It is well known that there are risks to such a worker are significant injury or death from working in such locations due to the possibility of falling. This is especially a risk for work locations which are at a great height, such as on the upper levels of buildings, structures and the like.

Conventional measures to protect workers proximate to the edge of construction floors and the like has been to provide fences located around the edge of the expose floor or roof to prevent workers from accessing such locations. Common difficulties with such approaches are that in construction sites, it is frequently necessary to access the portion of the floor or roof located behind the fence. In such locations, the fence will need to be removed from that location thereby rendering such fences ineffective. Furthermore, such fences in such locations may be removed entirely due to the need to access the edge of the floor or roof.

Other conventional solutions have been to provide a worker with a safety harness which may be tethered or otherwise secured to a location when a worker is required to work at a dangerous height. However, such a system requires a worker to first know when they are in such a dangerous location thereby placing an additional burden on the worker. Disadvantageously, many common safety harness systems do not provide any such indication to a worker of when they should utilize the system thereby relying upon the skill and knowledge of the worker.

### SUMMARY OF THE INVENTION

According to a first embodiment of the present invention there is disclosed an apparatus for protecting a worker from falling at a work site comprising a base plate operable to be anchored to a work surface, an anchor connected to the base plate and an upright extending substantially horizontally from the base plate.

The plate may comprise a square plate. The plate may have a plurality of bores therethrough. The bores may be sized to pass a fastener therethrough. The located proximate to corners of the base plate.

The anchor may comprise a loop. The loop may be hingedly connected to the base plate. The loop may be connected proximate to a center of the base plate.

The upright may be secured to proximate to the loop. The upright may extend to a free distal end. The upright may include a connector for securing a flexible tension member thereto proximate to the free distal end. The connector may comprise a bore through the upright. The upright may extend to a height of at least 36 inches. The anchor plates may be located at least 6 feet from a dangerous edge.

According to a further embodiment of the present invention there is disclosed a system for protecting a worker from falling at a work site comprising at least one anchor plate having an anchor connected thereto, at least one indicator plate having an anchor connected thereto and an upright extending therefrom, each upright having a bore through a free distal end thereof and a flexible tension member sized to extend through the bores between the uprights.

The flexible tension member may be selected from the group consisting of a rope, chain or cable.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a portion of a floor having a peripheral edge and a system for protecting a worker from falling off the peripheral edge according to a first embodiment of the present invention.

FIG. 2 is a perspective view of an apparatus for protecting a worker from falling at a work site comprising according to the system of FIG. 1.

FIG. 3 is a cross sectional view of the apparatus of FIG. 2 as taken through the upright and anchor.

FIG. 4 is a perspective view of an apparatus for protecting a worker from falling at a work site comprising according to a further embodiment of the present invention.

FIG. 5 is a side elevation view of a worker secured to the apparatus of FIG. 2 while working proximate to the edge of a floor.

### DETAILED DESCRIPTION

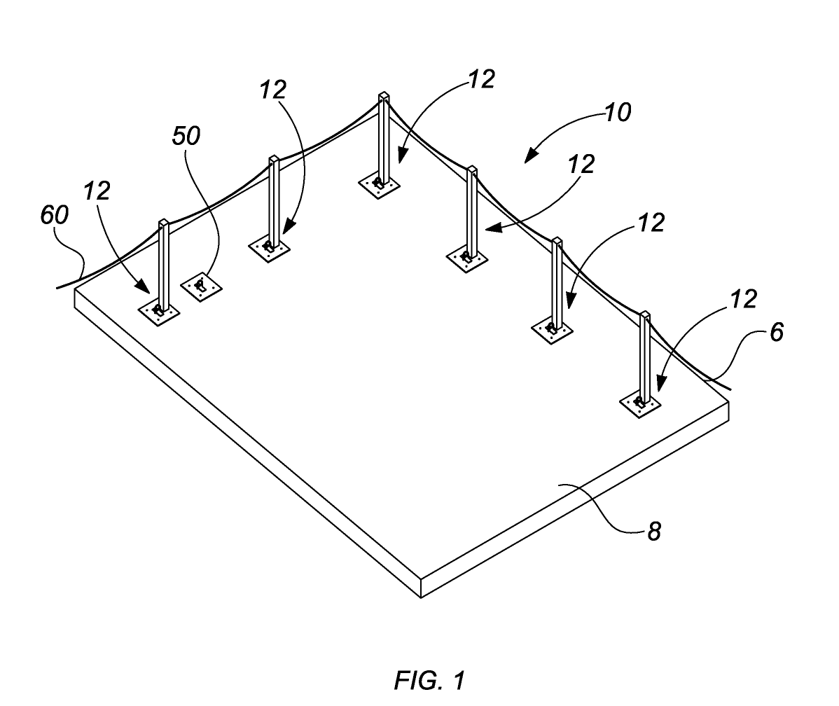

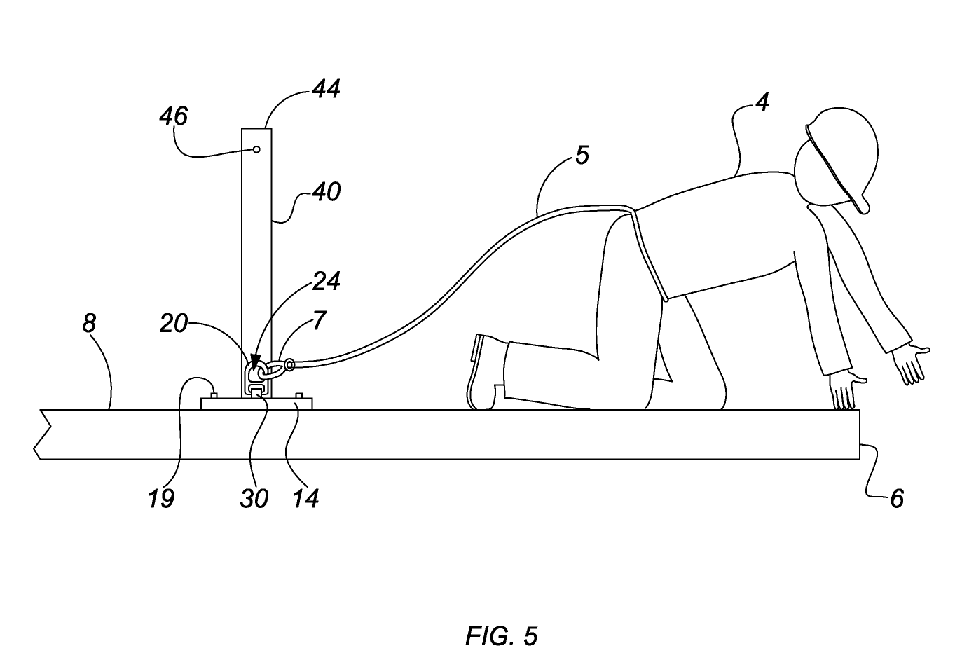

Referring to FIG. 1, a system for protecting a worker from falling at a work site according to the system of FIG. 1 according to a first embodiment of the invention is shown generally at 10. As illustrated in FIG. 1, the system 10 is located on a floor 8 having a peripheral edge 6 with may be under construction, or the system may be applied to a roof, or floor having an otherwise potentially dangerous edge therearound. The system 10 comprises a plurality of barrier forming posts 12 and may optionally include one or more anchor plates 50. The posts 12 are formed of a base plate 14, having anchor 20 connected thereto and an upright 40 extending substantially vertically therefrom. The posts 12 are securable to the floor 8, as will be more fully described below at a location spaced apart from the peripheral edge 6. In use, a worker may secure themselves to the anchor 20 with a tether, harness or other commonly known safety devices so as to prevent accidental falls over the edge of the floor 8 as illustrated in FIG. 5.

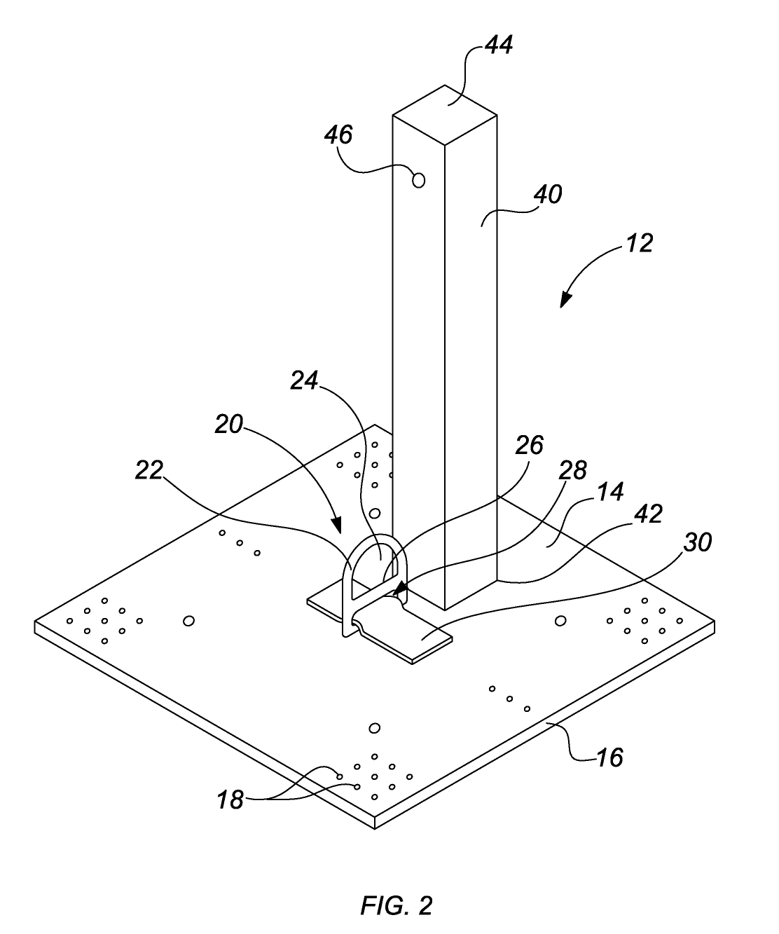

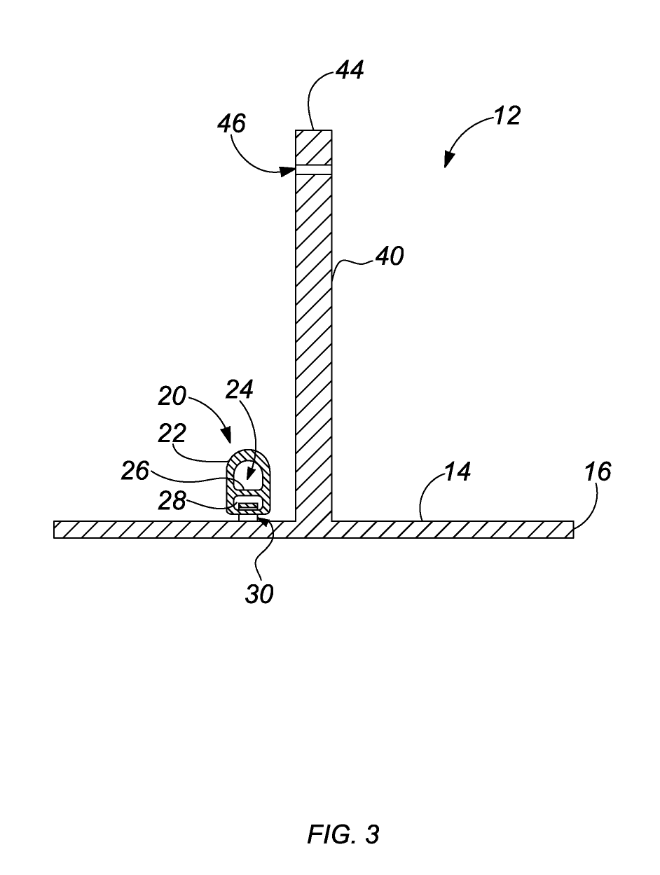

With reference to FIGS. 2 through 3, the base plate 14 comprises a substantially planar member having a peripheral edge 16 and a plurality of fastener bores 18 therethrough. As illustrated in FIG. 2, the fastener bores 18 may be arranged at any desired configuration to permit fasteners (not show), such as, by way of non-limiting example, bolts, nails or the like to be passed therethrough. The fastener bores 18 will also be selected to permit fasteners 19 of an appropriate size and strength to be passed therethrough, so as to securely fasten the base plate 14 to the floor 8 as illustrated in FIG. 5. By way of non-limiting example, the fastener bores may be selected to have a diameter between 3/16 and ⅝ inches (5 and 16 mm) although it will be appreciated that other sizes may be utilized as well. As illustrated the fastener bores 18 may be provided in a variety of locations across the base plate 14, such as in the corners, along the edges or any other location as desired by a user to correspond to the locations of new pre-existing fastener locations in the roof or floor 8.

The peripheral edge 16 of the base plate 14 may have a rectangular outline as illustrated, although it will be appreciated that any other shape may be utilized as well, such as, by way of non-limiting example, rectangular, circular oval. The base plate 14 is selected to have a size sufficient to permit the fastener bores 18 to be located sufficiently far enough apart to provide a secure connection to the floor 8 and resist any forces applied to the posts 12, such as, tension or bending moments. By way of non-limiting example, the base plate may have a rectangular outline having lengths of between 10 and 24 inches (25 and 610 mm) and may have a thickness of between ⅛ and ½ inches (3 and 13 mm) although it will be appreciated that other sizes may be utilized as well. The base plate may be formed of any suitable material having an adequate strength as desired by a user, such as, by way of non-limiting example, steel, stainless steel, aluminum, other metal alloys or composite materials.

The anchor 20 comprises a body hingedly secured to the base plate 14. The anchor 20 is formed of an outer member 22 arranged in to a continuous loop so as to form a first connection bore 24. The anchor may optionally include a dividing member 26 so as to form a separate base loop 28. In embodiments where there is no dividing member 26, it will be appreciated that only the connection bore 24 will be formed by the outer member 22. The outer member 22 and dividing member may be formed of any suitable material having an adequate strength as desired by a user, such as, by way of non-limiting example, steel, stainless steel, aluminum, other metal alloys or composite materials. The outer member and dividing member 26 may be formed by any known means, such as, welding, molding machining or forging and may be formed as a unitary member or may be formed of separate elements and thereafter connected together. The anchor 20 will be selected to be formed of a material having a thickness sufficient to provide a secure anchor for a worker in the event of a fall according to known methods in the art.

A fastening plate 30 is passed through the base loop 28 and thereafter secured to the base plate 14 by any known means, such as, by way of non-limiting example, welding, adhesives or fasteners, such as, bolts, screws, rivets or the like. The fastening plate 30 may be formed of any suitable material having an adequate strength as desired by a user, such as, by way of non-limiting example, steel, stainless steel, aluminum, other metal alloys or composite materials. The fastening plate 30 may be formed of a thickness and width sufficient to provide adequate strength to secure the anchor 20 to the base plate 14, such as, by way of non-limiting example, between 1½ and 5 inches (38 and 127 mm) wide and between ⅛ and ½ inches (3 and 13 mm) thick although it will be appreciated that other sizes may be utilized as well.

The upright 40 comprises an elongate member extending between proximate and distal ends, 42 and 44, respectively and having a bore 46 therethrough proximate to the distal end. The proximate end 42 of the upright 40 is secured to the base plate 14 by any known means, such as, by way of non-limiting example, welding, adhesives or fasteners, such as, bolts, screws, rivets or the like. The upright 40 may have any cross section as desired by a user, such as, by way of non-limiting example, square, rectangular, circular, oval, triangular, octagonal or irregular. The upright 40 is selected to have a height adequate to space the bore 46 at a distance above the base plate 14 so as to be operable to form a fence or other common height barrier. By way of non-limiting example, a height of between 38 and 48 inches (965 and 1219 mm) may be useful for forming a barrier of between 36 and 45 inches (914 and 1143 mm) high although it will be appreciated that other sizes may be utilized as well. The bores 46 is selected to have a size sufficient to permit a barrier member 60, such as by way of non-limiting example, a rope, chain, cable or other barrier member to be passed therethrough as will be more fully described below. By way of non-limiting example, a diameter of between ¼ and 1 inch (6 and 25 mm) may be useful although it will be appreciated that other sizes may be utilized as well.

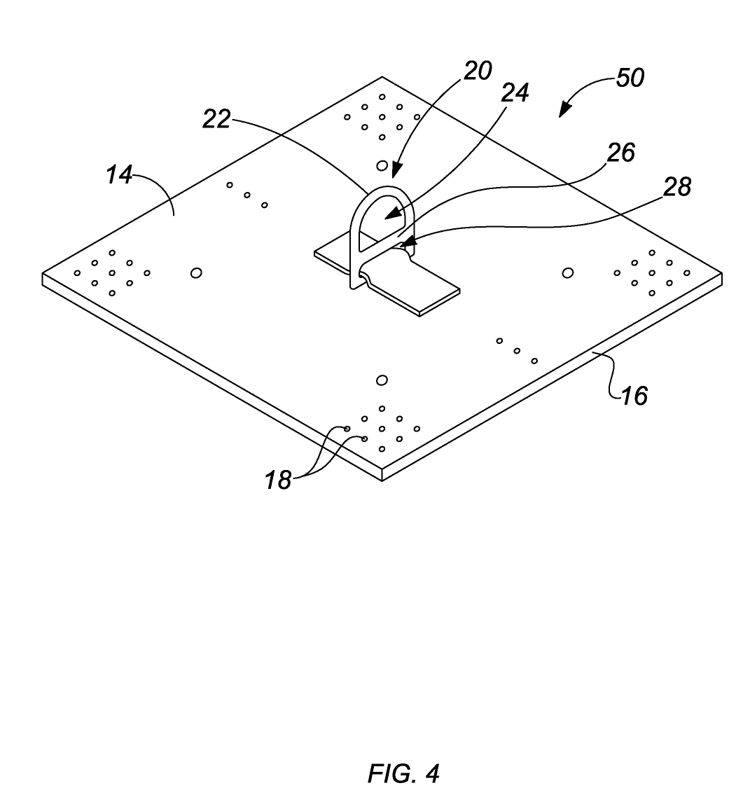

The upright 40 may be formed of any suitable material having an adequate strength as desired by a user, such as, by way of non-limiting example, steel, stainless steel, aluminum, other metal alloys or composite materials and may be secured to the base plate 14 by any known means, such as, by way of non-limiting example, welding, adhesives or fasteners, such as, bolts, screws, rivets or the like. As illustrated, the upright 40 and anchor 20 may be located proximate to a center of the base plate 14, although it will be appreciated that other locations may be utilized as well depending on the loading requirements on the post and space constraints of the intended mounting location. As illustrated in FIG. 4, the anchor plate 50 may be formed in a similar manner to the post 12 as including a base plate 14 and a pivotally secured anchor 20 thereto but not including an upright.

In operation, the posts 12 may be secured to the floor 8 at locations spaced apart from the peripheral edge 6 thereof by a distance sufficient to prevent accidental falls from workers 4 getting too close to the edge 6. This distance may be selected by a user depending upon the height of the floor as well as other environmental factors and the task to be performed by the workers such as, by way of non-limiting example, 40 inches (3 meters) although it will be appreciated that other distances may be useful as well. Additionally, one or more anchor plates 50 may also be secured to the floor 8 at a similar distance or otherwise selected to be spaced apart from the peripheral edge 6 to prevent injury from a fall of a worker. A barrier member 60, which is formed of a flexible tension member, such as by way of non-limiting example, a rope, chain, cable or other barrier member to be passed through the bores 46 of the uprights 40 to form a barrier or visual indication to a user. The barrier member 60 indicates to a worker that the space between the barrier member 60 and the peripheral edge 6 of the floor may be a more dangerous area and therefore greater care and/or further securing to the anchor 20 will be necessary when entering this area. When a worker 4 requires to approach the peripheral edge 6 of the floor, they may attach a connector, such as, by way of non-limiting example, a carabineer 7 or the like which is secured to the distal end of a rope 5 connected to a harness or the like worn by the user 4 to the connection bore 24 of the anchor 20. The rope 5 will have a length selected to prevent the worker 4 from falling over the edge 6. In such a manner, it will be observed that the barrier member 60 provides a visual indication to the worker while the anchor provides a secure location for the user to connect their harness or the like thereby separating these two functions from each other.

While specific embodiments of the invention have been described and illustrated, such embodiments should be considered illustrative of the invention only and not as limiting the invention as construed in accordance with the accompanying claims.

What is claimed is:

1. An apparatus for protecting a worker from falling at a work site comprising:
a base plate operable to be anchored to a work surface;
an anchor connected to said base plate; and
an upright extending substantially horizontally from said base plate.

2. The apparatus of claim 1 wherein said plate comprises a square plate.

3. The apparatus of claim 2 wherein said plate has a plurality of bores therethrough.

4. The apparatus of claim 3 wherein said bores are sized to pass a fastener therethrough.

5. The apparatus of claim 3 wherein said located proximate to corners of said base plate.

6. The apparatus of claim 1 wherein said anchor comprises a loop.

7. The apparatus of claim 6 wherein said loop is hingedly connected to said base plate.

8. The apparatus of claim 6 wherein said loop is connected proximate to a center of said base plate.

9. The apparatus of claim 1 wherein said upright is secured to proximate to said loop.

10. The apparatus of claim 1 wherein said upright extends to a free distal end.

11. The apparatus of claim 10 wherein said upright includes a connector for securing a flexible tension member thereto proximate to said free distal end.

12. The apparatus of claim 11 wherein said connector comprises a bore through said upright.

13. The apparatus of claim 1 wherein said upright extends to a height of at least 36 inches.

14. The apparatus of claim 1 wherein said anchor plates are located at least 6 feet from a dangerous edge.

15. A system for protecting a worker from falling at a work site comprising:
at least one anchor plate having an anchor connected thereto;
at least one indicator plate having an upright extending therefrom, each upright having a bore through a free distal end thereof; and
a flexible tension member sized to extend through said bores between said uprights.

16. The system of claim 15 wherein said indicator plate further includes an anchor connected thereto.

17. The system of claim 15 wherein said flexible tension member is selected from the group consisting of a rope, chain or cable.
